(19) United States
(12) Patent Application Publication
(10) Pub. No.: US 2023/0245258 A1
(43) Pub. Date: Aug. 3, 2023

(54) CAREER TOOLS BASED ON CAREER TRANSITIONS

(71) Applicant: MICROSOFT TECHNOLOGY LICENSING, LLC, REDMOND, WA (US)

(72) Inventors: Wenjia Ma, San Jose, CA (US); Prakruthi Prabhakar, Foster City, CA (US); Yiping Yuan, Sunnyvale, CA (US); Yanen LI, Foster City, CA (US); Tianqi Li, Santa Clara, CA (US); Arvind Murali Mohan, Sunnyvale, CA (US)

(21) Appl. No.: 17/590,660

(22) Filed: Feb. 1, 2022

(51) Int. Cl. G06Q 50/20; G06N 20/00

(52) U.S. Cl. CPC G06Q 50/2057; G06N 20/00

(57) ABSTRACT

Methods, systems, and computer programs are provided for presenting career information based on career transitions of members. One method comprises generating, using a machine-learning (ML) model, an embedding for a current job position of a member of an online service. The model is obtained by training a ML program with training data for job transitions of members. Further, the method includes generating, by the ML model, embeddings for career transitions, of members of the online service, that occurred within a predetermined time period. For each career transition, a similarity value is calculated between the embedding of the career transition and the embedding for the current job position. Further, the method includes operations for ranking the career transitions based on the similarity values, generating a career insight for the member based on the ranked career transitions, and causing presentation of the career insight on a user interface.

### TECHNICAL FIELD

The subject matter disclosed herein generally relates to methods, systems, and machine-readable storage media for providing tools that provide information and suggestions regarding actions to further users' careers.

### BACKGROUND

Planning a career may be a challenging task for people as there may be multiple options for advancement at a given time, such as changing jobs, going back to school, changing from a small company to a large company, etc. Most people would like to see how others manage their careers so they can look at options and set up realistic expectation for progress.

Looking at how others have managed their transitions (e.g., by searching in a professional social network service) may help a person, but it is difficult to navigate these websites to check one user at a time to determine patterns and possibilities.

### BRIEF DESCRIPTION OF THE DRAWINGS

Various of the appended drawings merely illustrate example embodiments of the present disclosure and cannot be considered as limiting its scope.

FIG. 1 is a screenshot of a user's profile, according to some example embodiments.

FIG. 2 is a diagram illustrating different career transitions, according to some example embodiments.

FIG. 3 is a chart illustrating vectorial representations of job positions and transitions, according to some example embodiments.

FIG. 4 is an example message for discovering career paths, according to some example embodiments.

FIG. 5 illustrates a process for generating insights, according to some example embodiments.

FIG. 6 illustrates the generation of career transition embeddings, according to some example embodiments.

FIG. 7 illustrates a process for finding relevant career transitions, according to some example embodiments.

FIG. 8 illustrates the training and use of a machine-learning program, according to some example embodiments.

FIG. 9 is a flowchart of a method for presenting career information based on the career transitions of a community of users, according to some example embodiments.

FIG. 10 is a block diagram illustrating an example of a machine upon or by which one or more example process embodiments described herein may be implemented or controlled.

### DETAILED DESCRIPTION

Example methods, systems, and computer programs are directed to presenting career information based on the career transitions of a community of users. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

What are needed are tools that assist users to see how other users in a similar situation have evolved their careers, including job changes, expected time for promotions, better companies to transition to, etc.

For the purposes of this description the phrases “an online social networking application” and “an online social network system” may be referred to as and used interchangeably with the phrases “an online system,” “an online service,” “a networked system,” or merely “a connections network.” It will also be noted that a connections network may be any type of an online network, such as, e.g., a professional network, an interest-based network, or any online networking system that permits users to join as registered members. For the purposes of this description, registered members of a connections network may be referred to as simply members. Further, some connections networks provide services to their members (e.g., search for jobs, search for candidates for jobs, job postings) without being a social network, and the principles presented herein may also be applied to these connections networks.

The online social networking application stores profile data that provides large-scale samples of individual career trajectories. By providing tools that provide information about the community career transitions, members benefit from the aggregated knowledge to guide their career planning. In one aspect, a career radar tool uses a career-transition model, which generates embeddings for job positions (e.g., title and company) and for career transitions in numerical vector spaces, to provide tools for analyzing career transitions of similar members. The career radar analyzes the underlying similarity among different career stages and interprets the career transition in the same embedding space as a function of transition characteristics, such as the number of years at the previous career stage and the educational background that may facilitate the transition.

One general aspect includes a method that includes an operation for generating, using a machine-learning (ML) model, an embedding for a current job position of a member of an online service, the ML model obtained by training a ML program with training data based on job transitions of members of the online service. Further, the method includes generating, by the ML model, embeddings for a plurality of career transitions, of a plurality of members of the online service, that occurred within a predetermined time period. For each career transition from the plurality of career transitions, a similarity value is calculated between the embedding of the career transition and the embedding for the current job position. Further, the method includes operations for ranking the plurality of career transitions based on the similarity values, generating a career insight for the member based on the ranked plurality of career transitions, and causing presentation of the career insight on a user interface.

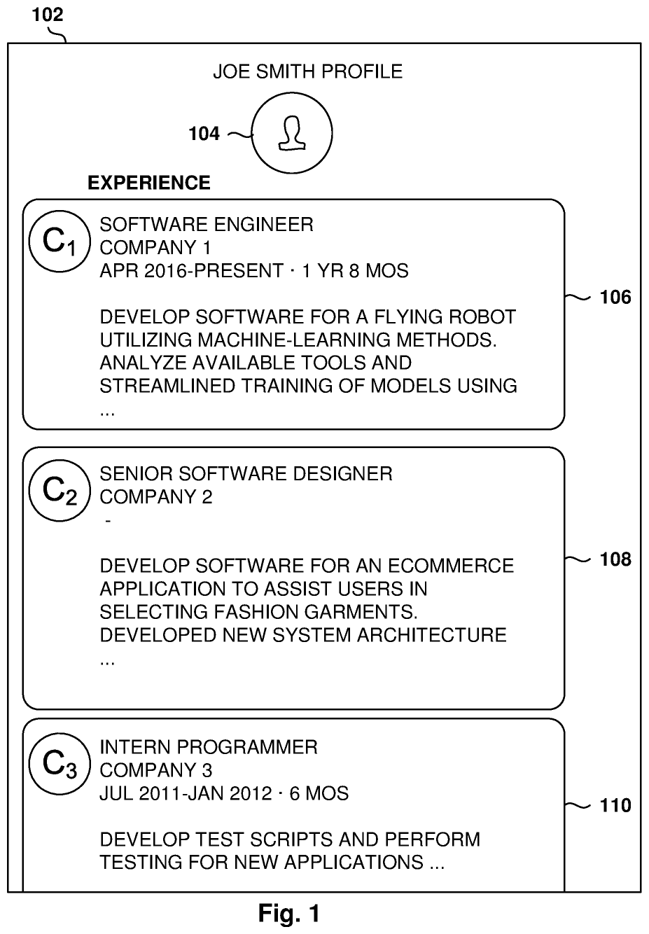

FIG. 1 is a screenshot 102 of a user's profile, according to some example embodiments. In the example embodiment of FIG. 1, the user's profile includes several job positions 106, 108, 110 held by the user 104.

In one example embodiment, each job position (106, 108, 110) includes a company logo for the employer (e.g., C₁, a title (e.g., software engineer), the name of the employer (e.g., Company 1), dates of employment, and a description of the job tasks or job responsibilities of the user 104. However, for job position 108, employment dates are unknown, so they are not shown.

In some example embodiments, the information on the user profiles may be categorized. For example, the company may include a company ID, a title may be assigned a title ID (where the title is standardized to cover a plurality of similar job titles), and a position may be assigned a position ID. In some example embodiments, each job position (member_position) of the user may be described utilizing a record with one or more of the following fields: {member_id: int, position_id: int, company_id: int, is_current: boolean (indicating if this is believed to be the user's current job), industry_id: int, position_start_time: long, position_end_time: long}. Other embodiments may include additional fields or fewer fields.

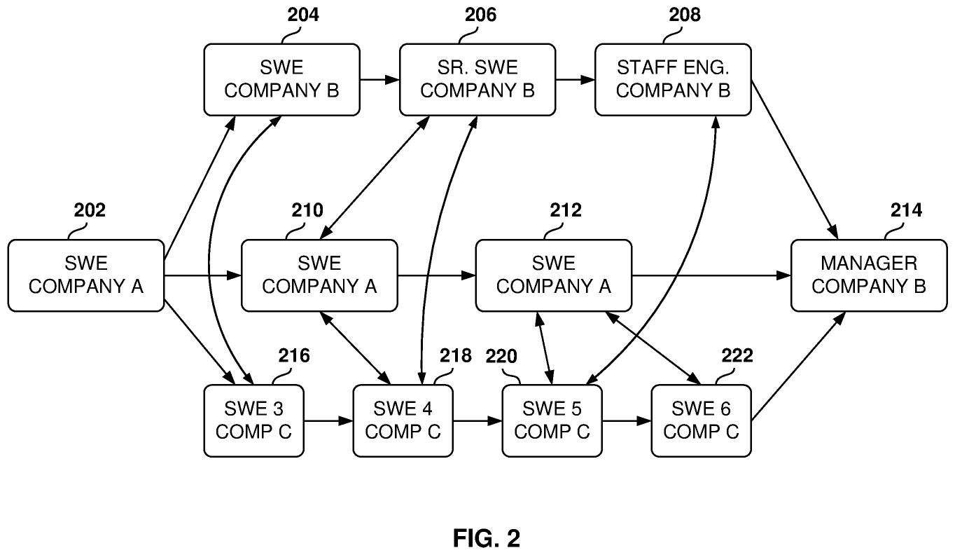

FIG. 2 is a diagram illustrating different career transitions, according to some example embodiments. Careers make take many paths, and some transitions between two job positions may also include many possible trajectories. A career transition refers to a change in employment of a member from a first job to a second job, where the second job includes a change in title or employer from the first job. The entity may be a company, a government organization, an educational institution, a non-profit organization, etc. The illustrated example is for career transitions based on job title and employer.

In this example, a software engineer 202 (SWE) at Company A may go through different paths to reach job position 214 for a manager at Company B. One path may follow job positions 204, 206, and 208; another path through job positions 210 and 212; and another path for job positions 216, 218, 220, and 222. Further, there may be transitions happening between these intermediate job positions, such as a transition from job position 206 to job position 218 (or vice versa), a transition from job position 212 to job position 222 (or vice versa), etc.

Some transitions involve changing employers, such as moving from Company A to Company B, and other transitions involve internal promotions or change of title, such as transferring from SWE to Senior SWE within the same company, or from SWE to manager. Therefore, the user may contemplate changing companies for advancement or wait to be promoted at the same company. The possibilities and combinations are very large, as there are many employers that will hire SWE's.

In some example embodiments, a career tool, referred to herein as career radar, provides tools to plan personalized career development with information to guide members' career planning. The career radar helps members answer questions, such as, “What are some potential next steps or trajectories that could help guide my short-term and long-term career?” and, “How can I learn more from people in my network, and people who share similar backgrounds with me, to plan my career steps?”

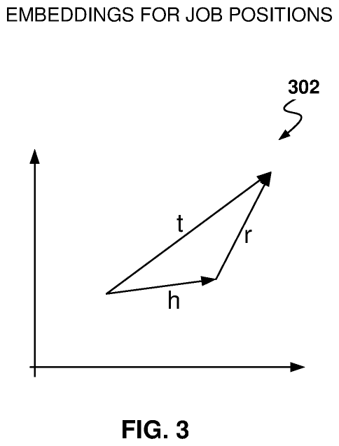

FIG. 3 is a chart illustrating vectorial representations of job positions and transitions, according to some example embodiments. A career transition graph 302 G is for representing positions and transitions. The career transition graph 302 is a directed graph where each node vᵢ represents a position defined by title and company (e.g., pair (title, company)), and each edge is a transition from a source node vᵢ to a target node vⱼ, where the edge is represented as (vᵢ, vⱼ).

An entity e is a term used in knowledge representation, in which a segment of a graph (e.g., defined as (source node, edge, target node)) is usually denoted by the triple (head entity, relation, tail entity) or (h, r, t). By definition, {e} is defined as the union of {h} and {t} ({h}∪{t}). In the context of job positions, the head entity h is the current (title, company) pair for a member, and the tail entity t is the member's next position defined by (new title, new company). It is noted that the new title may be the same as the previous title, or the new company may be the same as the previous company, but as long as one or both of title and company change, then there is a transition.

The purpose of modeling is to obtain the career-transition model that generates a numerical representation, referred to as an embedding, of the entities (i.e., job positions) and the transitions. In general, an embedding for an event is a vector with numerical values that captures the information associated with the event. That is, the purpose of modeling is to learn a mapping e→\vec{e}, where \vec{e} is the embedding vector for the entity e. In some example embodiments, the career-transition model generates the embeddings for the job positions and for the transitions.

In the illustrated example, h represents a position, the relation r represents a transition, and t is the position after the transition. The relation r is the connection between the head entity h and a tail entity t. That is, combining vectors h and r results in t, and the relation r is the transition information.

As with positions, the modeling for relations (i.e., transitions) is for learning the embedding of the relations. That is, the modeling is for learning the mapping r→\vec{r}, where \vec{r} is the embedding vector for the entity relation r.

In the career transition graph 302, embedding relations is not as straightforward as embedding positions. On the other hand, there is more flexibility on how relations are encoded.

In some example embodiments, the embedding for r encodes one or more of the following values:
The time (e.g., number of years, number of months) that a member has stayed in h before the member makes the career change to t;
The highest education degree a member holds when making the transition;
A value indicating if the member changed company in the transition;
A value indicating if the member changed occupation in the transition;
A value indicating if the member changed industry in the transition;
A similarity between the member's current skill set and skills set needed for the destination job position of the transition; and
A value indicating the member moved up, stayed at the same level, or moved with regard to seniority in the transition.

In some example embodiments, features represented by a number (e.g., a real number) (e.g., time and h) are placed in buckets, each bucket associated with a range of possible values, in order to make the features categorical, where each category is associated with a predefined number of possible values. Each categorical value is then subject to one-hot encoding, which simplifies the encoding of the feature values by creating binary vectors of fixed size that are input to the ML models for generating the embeddings. One hot encoding is a method of converting data so each categorical value is encoded into a vector with all zeroes except for one value of 1 for the vector element that represents each categorical value; that is, each categorical value is represented by a vector with a 1 in a different position for each of the categorical values. In some example embodiments, the embedding for r includes the Cartesian product of the aforementioned categorical features. Similar to entities, a featurized representation of the entity e is created using the aforementioned features.

Once the career transition embeddings are generated, it is possible to obtain insights related to career transitions based on the properties of the embeddings, where the embeddings of similar career transitions are closest to each other. For example, based on the career transition embeddings and using similarity comparisons, it is possible to forecast career transitions by analyzing how people that were in a similar career path evolved their career, identify members in similar career paths, provide recommendations on the best career path to obtain a target job position, etc.

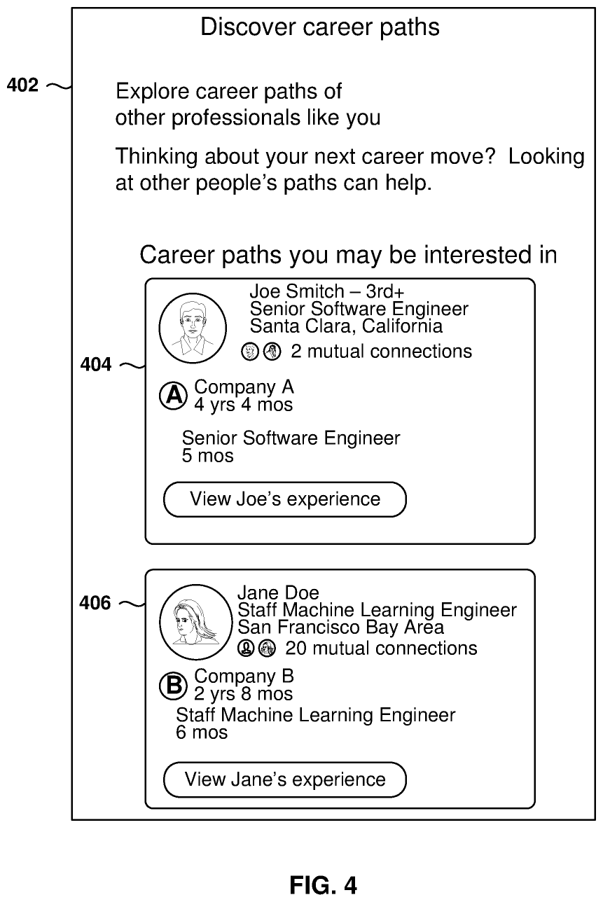

FIG. 4 is an example message for discovering career paths, according to some example embodiments. There are several career-path tools that can help a member plan their career. These tools are referred to herein as career radar. Career development is a great benefit for members and will increase engagement with the online service, which is a benefit for the online service.

On an online service with millions of members, finding similar candidates to a member could be challenging as it involves massive data computations. For example, analyzing millions of career transitions and then finding similarity to the transitions of the user is challenging. For example, to determine a similar career transition, the tool must be able to identify similarities of titles and companies in order to be able to obtain accurate metrics. For example, a member that is a “software engineer at Microsoft” would be similar to a member that is a “programmer at Apple,” although both the title and the company are different. If these similarities are not accounted for, the tool will miss many career transitions that are relevant to a user, which means less accurate predictions and the possibility of missing recommending good career transitions for the member.

Career radar assists a member in areas such as, potential next steps in the member's career to help guide short-term and long-term career goals, learning from people in my network, or people who share similar backgrounds, planning career steps, identifying career paths from the member's current position to the desired goal position.

Other solutions offer job-change notifications, which informs the user when others change jobs, but there are two limitations: the notifications may be restricted to direct social connections, and there is no relevance selection on whether this job change is insightful for a member's career growth.

The career radar can show job transitions that happened in the past for similar people, which is much more relevant than just showing people that recently changed jobs.

The illustrated email 402 is an example of career radar, where the online service sends this CTYMBII email to the member. The email informs the member that the member can explore career paths that other professionals in the same situation have taken. The email 402 also includes sample career paths that the member may be interested in, such as career path 404 and 406. Besides email 402, the same presentation may be provided to the member in other formats, such as texting, user feed of the online service, messaging within the online service, a custom option on the UI of the online service to present career-path information, in a video or other multimedia component, on a custom application executing on a mobile device, etc.

Each career path shows information about career paths that other members have taken, such as information on the current job, a previous job, and a button to select and see the member's complete job experience.

Another career radar tool helps the member decide between two job offers by providing information on possible career paths if the member takes each of the jobs. For example, how long it would take on average to get an internal promotion at each job.

Another example is to let the member choose a career objective as an input, and career radar recommends one or more career paths to achieve that goal, including possible intermediate job positions achieved by gaining seniority at the same job or by changing jobs to a different company.

Another application for career radar is the prediction of the next career stage. For example, if a member has been working at a Company A as a consultant for 5 years with a bachelor's degree, a prediction model may predict that the most likely transitions are to be a manager at Company A, to become a senior consultant at Company B, to become a manager at Company B, etc. The prediction model utilizes as input the job position of the member and generates one or more possible career transitions with a respective score indicating the probability of going through the career transition to a new job position. That is, career radar considers the fact that five-years of experience at Company A will probably lead to a more senior position at Company A or Company B since there is a high degree of mobility from Company A to Company B.

Another career radar tool makes predictions for hypothesized scenarios. For example, career radar may predict that the member will stay at the current position for two more years, or that the member will advance her career faster by obtaining a higher degree. This is an interesting insight for the member to decide whether to change jobs now or whether it is worthwhile to get a higher degree now. If the member is interested in different paths, career radar is also able to restrict predictions to job positions outside the current company or outside the current industry to assist with alternative career exploration.

Another career radar tool is for suggesting connection recommendations on the online service by recommending people who have recently made a job change and that the member may be interested in connecting with or viewing their profile. Instead of recommending job transitions, career radar recommends members who made those job transitions.

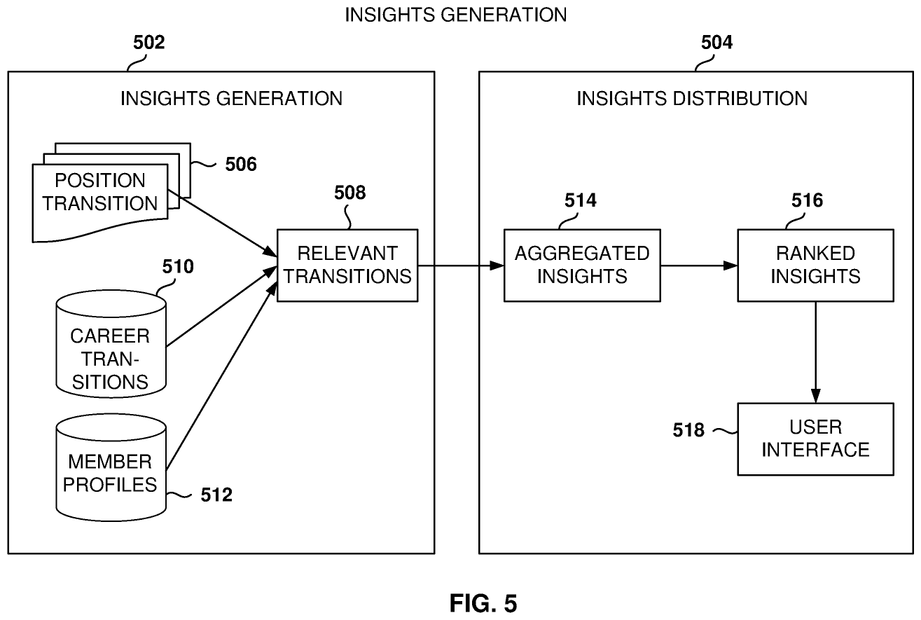

FIG. 5 illustrates a process for generating insights, according to some example embodiments. Insights generation is the process of generating career-transition information for members. The insight generation process includes insights generation 502 and insights distribution 504.

Insights generation 502 is performed periodically (e.g., daily, weekly, monthly), and at each cycle the career transitions 506 from a recent time period are collected. For example, the most recent month of career transitions is collected for insights generation, but other time periods may be selected.

Insights generation 502 includes analyzing the position transitions, career transitions 510, and member profiles 512, to determine the relevant transitions 508 for each member. For each member, based on their current job position and other personalized information, a predefined number of most relevant career transitions (e.g., 100-1000 career transitions) are selected based on similarity of the respective embeddings. In some example embodiments, an efficient nearest neighbor search is used.

Within insights distribution 504, aggregated insights 514 are generated for the relevant transitions, 508 and then the aggregated insights 514 are ranked using a ranking model based on the relevance for the member. The ranking model generates scores for the relevant transitions, where the score indicates the similarity of the career transitions to the job position of a member. One or more of the ranked insights 516 are then presented on a user interface 518 based on their scores, such as a user interface at the online service, or via messaging, such as an email or in-app communication.

Some examples of insights, for a member with position Pₐ at Company A, include the following:
N₁ members in a similar position to Pₐ changed into a different position P_{b} recently;
N₂ members at position P_{b} changed into a different position P_{c} within the time window;
N₃ members of a similar position Pₐ successfully changed into a different position P_{b} after they worked at Pₐ for Y years. Another example is after the member got a degree D or acquired a skill S;
N₄ software engineers have been promoted to P_{c} at Company B while noting that, on average, it takes 2 years and 3 months for such a promotion;
N₅ software engineers at Company A have become P_{c} (a promotion) at Companies B, C, and D;
N6 software engineers are moving to Company A from other companies; and
N7 percent of members with similar backgrounds as the member (e.g., title, company, degree) changed their occupation in their most recent career transition.

One aggregated insight includes combining insights with open job postings to recommend to the member relevant next-step jobs. For example, “Based on the recent career transitions in your network, title X at company Y would be recommended for your next job. Apply now!” Another insight would be to add information such as salary increase and number of opportunities at the hiring company.

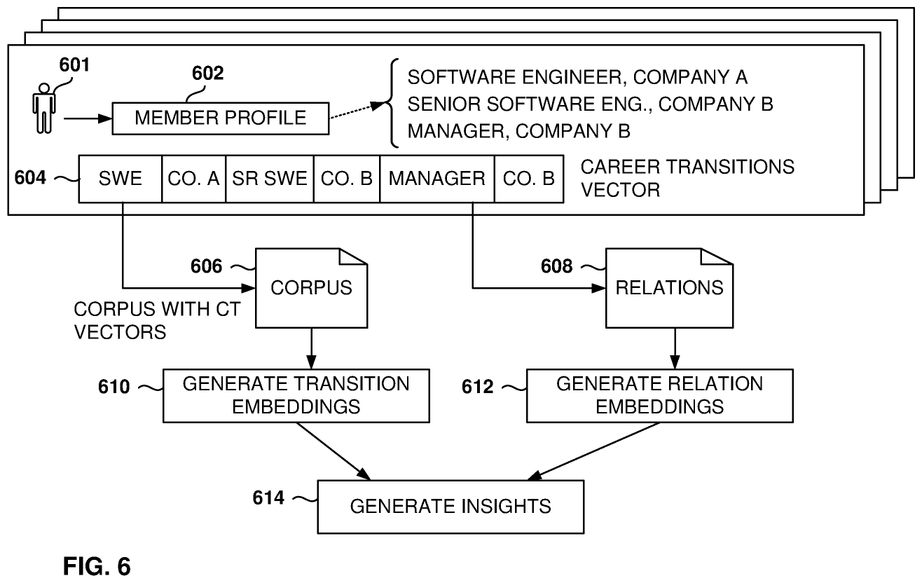

FIG. 6 illustrates the generation of career transition embeddings, according to some example embodiments. A transition embedding is an embedding that has been calculated for one career transition. Thus, in some example embodiments, the career transition embedding may be based on company and a title, but other embodiments may include additional features, such as an educational institution, a degree, etc.

In the illustrated example, the member 601 has a member profile 602 that holds information about the member 601. In the illustrated example, the member 601 was a software engineer at Company A, then a senior software engineer at Company B, and then a manager at Company B.

A career transitions vector 604 is created by concatenating the information associated with the career changes of the member 601. In some example embodiments, categorical features are described as one-hot vectors, as described above. In other example embodiments, one or more of the features are represented with identifiers (e.g., an integer number or a real number). For example, each company in the social network has its unique company identifier (e.g., 4397). In other embodiments, a different vector is created for each career transition.

Since a goal is to learn about the position transition information using the member job transition graph, this high dimensional graph space is mapped into a relatively low dimensional vector space to embed the transition information. In this way, each entity embedding vector encodes the semantics of the (title, company) pair and each relation embedding vector encodes the transition between two entities. One advantage of embedding the transition graph into a vector space is that there are straightforward and well-defined calculations for operating on career transitions. For example, the transition between two entities can be viewed as a translation operation in the vector space and the similarity between two entities can be calculated using cosine similarity.

The career transitions vector 604 is formed by concatenating the identifiers associated with the career transitions of the member. In general, the career transitions vector 604 has the format of (a₁, b₁), (a₂, b₂), (a₃, b₃), . . . (aₙ, bₙ), where aᵢ is an identifier for an educational institution or a company and bᵢ is an identifier for a title. The pairs of (aᵢ, bᵢ) are included in chronological order, where the pair corresponding to the current occupation of the member is last in the list, but the opposite order may also be used. In some example embodiments, the career transitions vector 604 includes companies and titles without educational institutions. For the member 601, the career transitions vector 604 includes identifiers for software engineer, Company A, senior software engineer. Company B, manager, and Company B.

The career transitions vector 604 is calculated for the members of the social network, and the combination of the career transitions vectors form a corpus 606. The corpus 606 is used to generate the transition embeddings (operation 610). Further, relations data 608 is generated from the member profile 602 and the career transitions vector 604, to generate 612 the relation embeddings.

A career-transition model generates embeddings for the job positions such that job positions (e.g., title and company) that are similar will have embeddings proximate to each other while job positions that are not similar will have embeddings that are not proximate to each other. For example, the embedding of a member of technical staff at eBay is very similar to the embedding of a data scientist at Facebook. Further, the embedding of a vice president at Goldman Sachs will be very different from the embedding of a vice president at Google. Further, the career-transition model also generates embeddings for the transitions. More details on the generation of the career transitions vector 604 are provided in patent Ser. No. 16/429,365, issued Dec. 21, 2021, and titled “Data Selection Based on Career Transition Embeddings,” which is hereby incorporated by reference.

One example of generating insights 614 is to predict the next job position, or positions, for a member. A prediction model is generated by training with the online service career transition graph represented by the career transition vectors 604, and member-profile information. The prediction model predicts the next job positions based on the current job position and other personalized information from the member profile 602 (e.g., education, number of years at the current position, etc.).

On an online service with millions of members, finding similar candidates to a member could be challenging as it involves massive data computations. In some embodiments, the problem is solved by approaching the solutions as a nearest neighbor problem in the common space where the entity and the item are embedded. In essence, the problem is finding a candidate set of items that are “near” the source item with respect to a particular distance metric.

In some example embodiments, the TransE algorithm is used for creating the career-transition model. The TransE, as its name suggests, has been used for language translations problems based on the transitions from one word to the next while doing translations. However, embodiments presented herein provide a novel use of the TransE algorithm in a different type of application. Instead of considering text for translation, the TransE algorithm is customized to the career-transition problem by using specific features related to job positions and career transitions.

The TransE algorithm develops embeddings in a k-dimensional space (k being a hyperparameter) for every entity and every relationship such that if two entities h and t have a relationship l, then h+l≈t. Embeddings for every relationship and every entity are randomly initialized with a uniform distribution between −6/sqrt(k) and 6/sqrt(k). Embeddings for the relationship embeddings are then normalized by their magnitude. Next, the training takes place to generate the career-transition model for embedding the job positions and the career transitions. The number of iterations is a configurable hyperparameter, and for some number of iterations, the following is performed:
1. The entity embeddings are normalized by their magnitudes;
2. A batch of actual (h, l, t) triples is sampled from the edges of the graph.
3. For each of the triples, a corrupted triple is created in which one of h or t is replaced by a random node in the graph.
4. A loss function is defined as max(0, y+d(h,l,t)-d(h′,l,t′)). Further, y is a margin included to prevent trivial loss minimization by making the embeddings for all nodes the same, and d is a distance function. The gradient of this loss function is summed with respect to each embedding and then each embedding is updated by this sum times a learning rate.

In some embodiments, the TransE algorithm uses one-hot encoding for entity and relations. For example, the categorical features described above are encoded using one-hot encoding. Entities and relations are indexed so that every entity and relation have a unique index. The unique index is then passed to a neural network's (e.g., TensorFlow) embedding layer.

The learning objectives are formulated such that h+r is close to t if such a triple (h, r, t) exists in the dataset. The loss function is defined as:

$$L = {\sum }_{( h , r , t ) ∈ S} {\sum }_{( h ′ , r , t ′ ) ∈ S {′}_{( h , r , t )}} {[ γ + d ( h + r , t ) - d ( {h}^{′} + r , {t}^{′} ) ]}_{+}$$

Here, d(x, y) denotes a dissimilarity measure (such as L₁-norm, L₂-norm, cosine distance, etc.) between vector x and y. In one embodiment, L₂-norm. Further, [x]₊ denotes the positive part of x, y is a hyperparameter for margin that is greater than zero, S denotes the positive training data, and S′ denotes the negative training data, which means that the triples do not exist in the career transition graph. The positive training data includes the data associated with the positive part of x. The negative training data is constructed by either corrupting head entity h or tail entity t (changing either head or tail entity in the original triple to a random entity) to generate data points where h+r is not close to t. The optimization essentially tries to minimize the dissimilarity between h+r and t while maximizing the dissimilarity between h′+r and t′.

In other embodiments, other variations of TransE are used, such as TranH, TranR, TranD that have been shown via experimentation to provide better performance in some embodiments. The margin loss L(h, r, t) is equal to max(0), fᵣ(h, t)ₚₒₛ-fᵣ(h, t)_{neg}+margin), and the basic principles of each model are summarized as follows:
TransE: h+r≈t
   fᵣ(h, t)=∥h+r-t∥
TrandH: h_{⊥}+dᵣ≈t_{⊥}
   h_{⊥}=h-wᵣ^{T}hwᵣ,
   t₁₉₅=t-wᵣ^{T}twᵣ.
   fᵣ(h, t)=∥h_{⊥}+dᵣ-t_{⊥}∥₂² (translating entities to a hyperplane by a relation transformation matrix)
TransR:
   hᵣ=hMᵣ
   tᵣ=tMᵣ.
   fᵣ(h, t)=∥hᵣ-+r-tᵣ∥₂² (for each relation r, a projection matrix MrϵR_{kxd} is set, which may projects entities from entity space to relation space).
TransD:
   h_{⊥}=Mᵣₕh, t₁₉₅ =Mᵣₜt.
   fᵣ(h, t)=∥h_{⊥}+r-t₁₉₅∥₂² (two mapping matrices Mᵣₕ, MᵣₜϵR mxn to project entities from entity space to relation space).

During experimentation, TransD and TransE showed better predictive performance than TransE. The main benefit was being able to embed r into a vector with a smaller dimension than h. For example, h may have a dimension between 100 and 200 while r may have a dimension between 5 and 20.

Thus, the embeddings created by the career-transition model take into consideration the similarities among career transitions, including similarity of titles and company. The multilayer neural network is used to learn their interactions via training, and the resulting model outputs the embeddings for career positions (nodes) and career transitions (edges).

For example, the career-transition model may learn from the career transitions that Associate Buyer at Sears, Inventory Manager at Sears, Divisional Merchandise Manager at Sears, and Senior Inventory Analyst at Sears are very similar positions without any additional knowledge of the title and the company. Across companies, the career-transition model will learn that Senior Manager at Deloitte is very similar to Senior Consultant at BearingPoint.

The job position embedding is useful to generate insights 614, such as recommending jobs or ranking job search results for the online service. For example, the embedding features can be used as follows:
1. Compute the embedding from a member's profile and get the member's job-position embedding (current title and company) using the career-transition model.
2. For a given job (company, job title and seniority for example), calculate the embeddings for the job using the career-transition model.
3. Use the results from #1 and #2 to determine similarities (e.g., cosine similarity, or Hamad product) between the member and the given job.

When determining similarity of job-position embeddings, there are several options, such as considering the same source position and ignoring the edge as similar, considering the same source position and the same edge as similar, or considering the same expertise level (originated from source position plus edge in the same dimension), but not necessarily the same position, as the same.

In one embodiment, referred to as status match, the embedding for the career transition for a member CT_{member} is calculated by concatenating the embedding of the source position E_{source} and the embedding of the edge E_{edge}.

For example, a software engineer in Google, with two years of experience in the position will be similar to other software engineers at google that have been two years in the position.

In another embodiment, referred to as knowledge match, CT_{member} is calculated by adding E_{source} and E_{edge}.

For example, a software engineer at Google with two years in the position will be similar to a senior software engineer in Company A after staying one year in Company A. In this example, the embeddings are considered similar (e.g., a score of 1 in a range from 0 to 1) when the source position and the edge match in a dimension where they are of the same expertise level.

In another embodiment, a Nearest Neighbor Search algorithm is used and the similarity score computed for each (member's job position, candidate's job position) pair, where the candidate member is the member of the online service that would be similar to the given member. This is represented by the following equation:

Distance(CT_{member},CT_{candidate})=\sqrt{(CT_{member}-CT_{candidate})²}

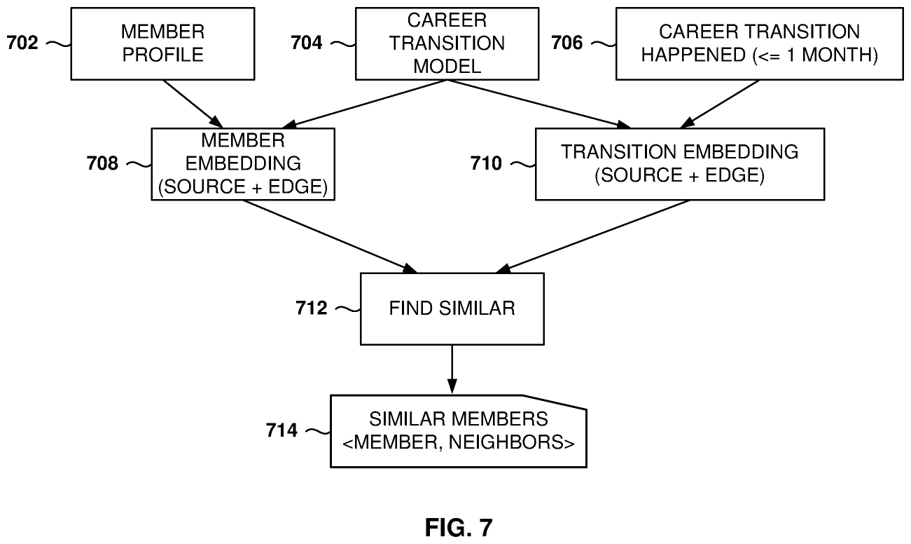

FIG. 7 illustrates a process for finding relevant career transitions, according to some example embodiments. At operation 708, the embedding for the current position of the member is calculated by the career-transition model using the member profile 702.

At operation 710, transition embeddings are calculated, by the career-transition model 704, for career transitions of members that happened within a predefined period (e.g., last 30 days). In some example embodiments, a subset of the career transitions 706 may be used if the number is very large, such as limiting the number of career transitions to a number between 100 and 10,000.

At operation 712, a search is performed to find transition embeddings that are similar to the member embedding, which results in a set of similar members 714 (referred to as neighbors in the graph due to the proximity to the members). Based on the similarity, career radar may search for useful information for the member, such as the examples described above with reference to FIG. 4, to find CTYMBII, decide between job offers, predict the next career transition, propose a career path, etc.

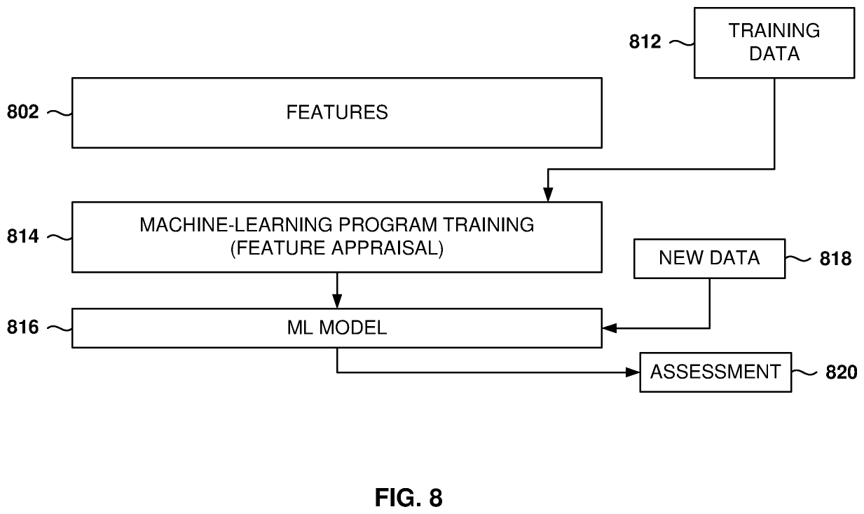

FIG. 8 illustrates the training and use of a machine-learning program, according to some example embodiments. In some example embodiments, machine-learning programs (MLP), also referred to as machine-learning algorithms or tools, are utilized to perform operations associated with career transitions, such as finding people with similar profiles that recently had a career transition, showing career transitions for similar people, etc.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 816 from example training data 812 in order to make data-driven predictions or decisions expressed as outputs or assessments 820. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data and generate embeddings.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, example ML models 816 include the career-transition model that generates embeddings for job positions and career transitions, and a predictions model that predicts one or more career transitions for a member. The training data 812 comprises examples of values for the features 802. In some example embodiments, the training data comprises labeled data with examples of values for the features 802 and labels indicating the outcome. The machine-learning algorithms utilize the training data 812 to find correlations among identified features 802 that affect the outcome. A feature 802 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 802 may be of different types and may include one or more of features for member, job postings, companies, career transition embeddings, and other features (member posts, web activity, followed companies, etc.). The features for the member include as information from the member profile, such as job positions helps, current job position, skills, education, address, career transitions, etc. Some features may be derived from the member information, such as the time that a member has stayed in a job position before changing job position, the highest education degree a member holds when making the transition, whether the member changed company after the transition, whether the member changed occupation after the transition, whether the member changed industry after the transition, similarity between the member's current skill set with skills set needed for the transition, and whether the member moved up, stayed at same level, or moved with regard to seniority in the transition.

During training 814, the ML program, also referred to as ML algorithm or ML tool, analyzes the training data 812 based on identified features 802 and configuration parameters 811 defined for the training. The result of the training 814 is the ML model 816 that is capable of taking inputs to produce assessments.

Training an ML algorithm involves analyzing large amounts of data (e.g., from several gigabytes to a terabyte or more) in order to find data correlations. The ML algorithms utilize the training data 812 to find correlations among the identified features 802 that affect the outcome or assessment 820. In some example embodiments, the training data 812 includes career transitions of members of the online service.

The ML algorithms usually explore many possible functions and parameters before finding what the ML algorithms identify to be the best correlations within the data; therefore, training may make use of large amounts of computing resources and time.

Many ML algorithms include configuration parameters, and the more complex the ML algorithm, the more parameters there are that are available to the member. The configuration parameters define variables for an ML algorithm in the search for the best ML model. The training parameters include model parameters and hyperparameters. Model parameters are learned from the training data, whereas hyperparameters are not learned from the training data, but instead are provided to the ML algorithm.

When the ML model 816 is used to perform an assessment, new data 818 is provided as an input to the ML model 816, and the ML model 816 generates the assessment 820 as output. For example, when a job position is provided, the ML model 816 generates an embedding for the job position.

In addition, other models may be generated to make other predictions, such as next career move, similar members with recent transitions, job recommendations based on expected job transitions, etc.

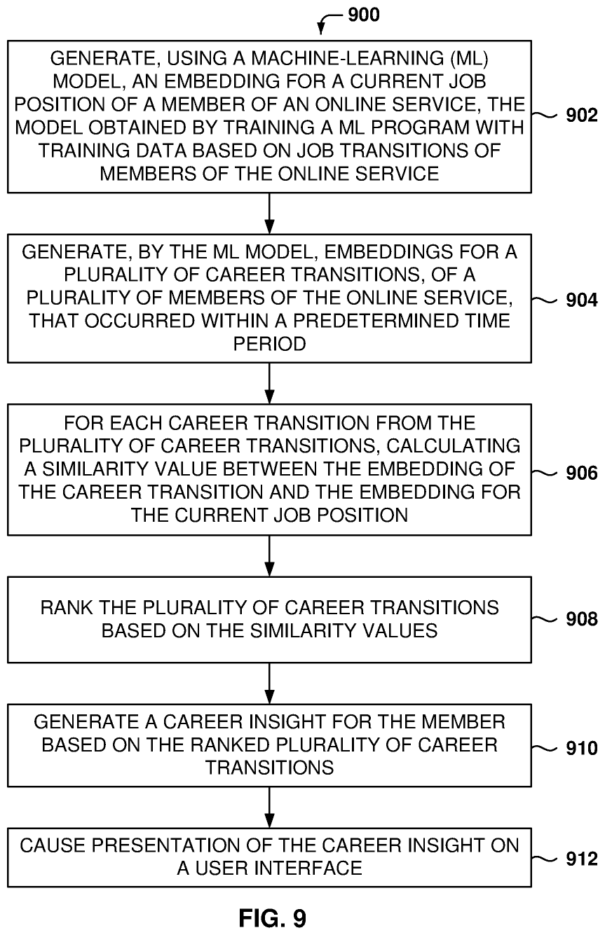

FIG. 9 is a flowchart of a method 900 for presenting career information based on the career transitions of a community of members, according to some example embodiments. While the various operations in this flowchart are presented and described sequentially, one of ordinary skill will appreciate that some or all of the operations may be executed in a different order, be combined or omitted, or be executed in parallel.

Operation 902 is for generating, using an ML model, an embedding for a current job position of a member of an online service, where the model is obtained by training an ML program with training data based on job transitions of members of the online service.

From operation 902, the method 900 flows to operation 904 for generating, by the ML model, embeddings for a plurality of career transitions, of a plurality of members of the online service, that occurred within a predetermined time period.

From operation 904, the method 900 flows to operation 906 where, for each from the plurality of career transitions, a similarity value is calculated for a similarity between the embedding of the career transition and the embedding for the current job position.

From operation 906, the method 900 flows to operation 908 for ranking the plurality of career transitions based on the similarity value of the career transitions.

From operation 908, the method 900 flows to operation 910 to generate a career insight for the member based on the ranked plurality of career transitions.

From operation 910, the method 900 flows to operation 912 to cause presentation of the career insight on a user interface.

In one example, the method 900 further comprises predicting, by the prediction ML model, a next job position for the member based on the current job position of the member and profile information of the member, the prediction ML model being generated with prediction training data comprising the embeddings for the plurality of career transitions and profile information of the members of the online service

In one example, the training data includes information on career transitions of members based on member's profiles.

In one example, the training data includes features comprising time that a member has stayed in a job position before changing to another job position, highest education degree of the member, value indicating if the member changed company in the transition, value indicating if the member changed occupation in the transition, value indicating if the member changed industry in the transition, a similarity value between member's current skill set and skills set needed for a destination job position of the transition, and value indicating if the member moved up, stayed at same level, or moved with regard to seniority in the transition.

In one example, the similarity value between the member's current skill set and the skills set needed for the destination job position is calculated using cosine similarity or a Hamad product.

In one example, the embeddings for the plurality of career transitions are vectors with a smaller dimension than the embedding for the current job position.

In one example, the career insight for a member M1 at position Pₐ in company Cₐ is selected from a group comprising: number of members in a similar position to Pₐ that changed into a different position P_{b} within a predefined time period; number of members at position P_{b} that changed into a different position P_{c} within the predefined time period; number of members at position Pₐ that successfully changed into P_{b} after working at Pₐ for a given number of years; and number of members at Pₐ that were promoted at company C_{b}.

In one example, the career insight is for suggesting a Career Transition You May Be Interested In (CTYMBII) that provides one or more career paths for the member.

In one example, the career insight is for providing a recommendation to decide between two job offers based on possible career paths.

In one example, the career insight is for providing an option to choose a career objective as an input and recommending one or more career paths to achieve the career objective, including possible intermediate job positions achieved by gaining seniority at a same job positing or by changing to a different company.

In one example, the career insight is for predicting one or more suggestions for a next career transition for the member.

In one example, the career insight is for recommending connections base on career transitions of the recommended connections.

Another general aspect is for a system that includes a memory comprising instructions and one or more computer processors. The instructions, when executed by the one or more computer processors, cause the one or more computer processors to perform operations comprising: generating, using a machine-learning (ML) model, an embedding for a current job position of a member of an online service, the model obtained by training an ML program with training data based on job transitions of members of the online service; generating, by the ML model, embeddings for a plurality of career transitions, of a plurality of members of the online service, that occurred within a predetermined time period; for each from the plurality of career transitions, calculating a similarity value for a similarity between the embedding of the career transition and the embedding for the current job position; ranking the plurality of career transitions based on the similarity value of the career transitions; generating a career insight for the member based on the ranked plurality of career transitions; and causing presentation of the career insight on a user interface.

In yet another general aspect, a machine-readable storage medium (e.g., a non-transitory storage medium) includes instructions that, when executed by a machine, cause the machine to perform operations comprising: generating, using a machine-learning (ML) model, an embedding for a current job position of a member of an online service, the model obtained by training an ML program with training data based on job transitions of members of the online service; generating, by the ML model, embeddings for a plurality of career transitions, of a plurality of members of the online service, that occurred within a predetermined time period; for each from the plurality of career transitions, calculating a similarity value for a similarity between the embedding of the career transition and the embedding for the current job position; ranking the plurality of career transitions based on the similarity value of the career transitions; generating a career insight for the member based on the ranked plurality of career transitions; and causing presentation of the career insight on a user interface.

In view of the disclosure above, various examples are set forth below. It should be noted that one or more features of an example, taken in isolation or combination, should be considered within the disclosure of this application.

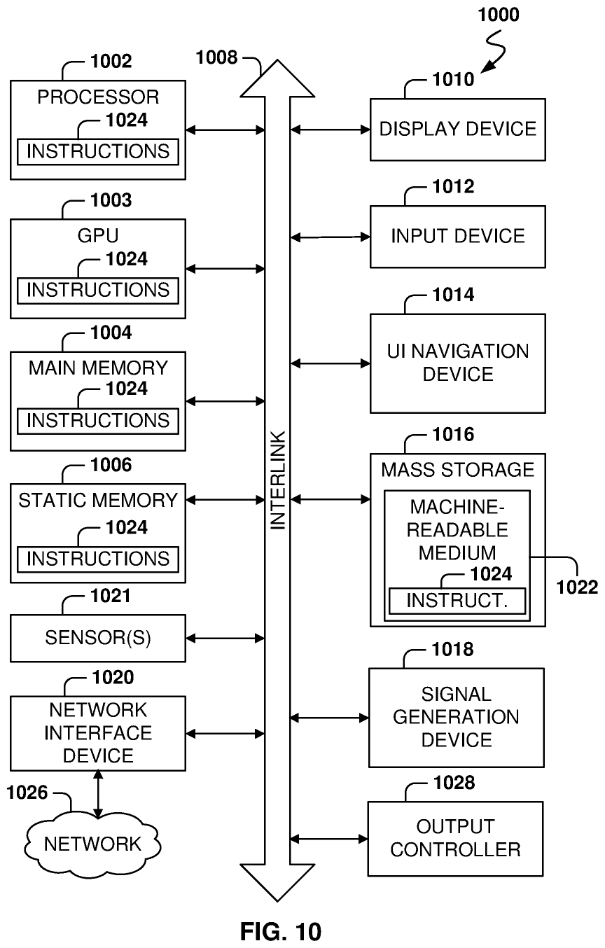

FIG. 10 is a block diagram illustrating an example of a machine 1000 upon or by which one or more example process embodiments described herein may be implemented or controlled. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. Further, while only a single machine 1000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1000 may include a hardware processor 1002 (e.g., a central processing unit (CPU), a hardware processor core, or any combination thereof), a graphics processing unit (GPU) 1003, a main memory 1004, and a static memory 1006, some or all of which may communicate with each other via an interlink (e.g., bus 1008). The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touch screen display. The machine 1000 may additionally include a mass storage device (e.g., drive unit) 1016, a signal generation device 1018 (e.g., a speaker), a network interface device 1020, and one or more sensors 1021, such as a Global Positioning System (GPS) sensor, compass, accelerometer, or another sensor. The machine 1000 may include an output controller 1028, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, within the hardware processor 1002, or within the GPU 1003 during execution thereof by the machine 1000. In an example, one or any combination of the hardware processor 1002, the GPU 1003, the main memory 1004, the static memory 1006, or the mass storage device 1016 may constitute machine-readable media.

While the machine-readable medium 1022 is illustrated as a single medium, the term “machine-readable medium” may include a single medium, or multiple media, (e.g., a centralized or distributed database, and/or associated caches and servers) configured to store the one or more instructions 1024.

The term “machine-readable medium” may include any medium that is capable of storing, encoding, or carrying instructions 1024 for execution by the machine 1000 and that cause the machine 1000 to perform any one or more of the techniques of the present disclosure, or that is capable of storing, encoding, or carrying data structures used by or associated with such instructions 1024. Non-limiting machine-readable medium examples may include solid-state memories, and optical and magnetic media. In an example, a massed machine-readable medium comprises a machine-readable medium 1022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
generating, using a machine-learning (ML) model, an embedding for a current job position of a member of an online service, the ML model obtained by training a ML program with training data based on job transitions of members of the online service;
generating, by the ML model, embeddings for a plurality of career transitions, of a plurality of members of the online service, that occurred within a predetermined time period;
for each career transition from the plurality of career transitions, calculating a similarity value between the embedding of the career transition and the embedding for the current job position;
ranking the plurality of career transitions based on the similarity values;
generating a career insight for the member based on the ranked plurality of career transitions; and
causing presentation of the career insight on a user interface.

2. The method as recited in claim 1, further comprising:
predicting, by a prediction ML model, a next job position for the member based on a current job position of the member and profile information of the member, the prediction ML model being generated with prediction training data comprising the embeddings for the plurality of career transitions and profile information of the members of the online service.

3. The method as recited in claim 1, wherein the training data comprises information on career transitions of members based on member's profiles.

4. The method as recited in claim 3, wherein the training data comprises features comprising one or more of:
time that a member has stayed in a job position before changing to another job position, highest education degree of the member, value indicating if the member changed company in the transition, value indicating if the member changed occupation in the transition, value indicating if the member changed industry in the transition, a similarity value between member's current skill set and skills set needed for a destination job position of the transition, and value indicating if the member moved up, stayed at same level, or moved with regard to seniority in the transition.

5. The method as recited in claim 1, wherein the similarity value is calculated using cosine similarity or a Hamad product.

6. The method as recited in claim 1, wherein the embeddings for the plurality of career transitions are vectors with a smaller dimension than the embedding for the current job position.

7. The method as recited in claim 1, wherein the career insight for a member M₁ at position Pₐ in company Cₐ is one or more of:
number of members in a similar position to Pₐ that changed into a different position P_{b} within a predefined time period;
number of members at position P_{b} that changed into a different position P_{c} within the predefined time period;
number of members at position Pₐ that successfully changed into P_{b} after working at Pₐ for a given number of years; and
number of members at Pₐ that were promoted at company C_{b}.

8. The method as recited in claim 1, wherein the career insight is for suggesting one or more career paths for the member.

9. The method as recited in claim 1, wherein the career insight is for recommending a selection of one of two job offers based on possible career paths.

10. The method as recited in claim 1, wherein the career insight is for providing an option to choose a career objective as an input and recommending one or more career paths to achieve the career objective.

11. The method as recited in claim 1, wherein the career insight is for recommending connections based on career transitions of the recommended connections.

12. A system comprising:
a memory comprising instructions; and
one or more computer processors, wherein the instructions, when executed by the one or more computer processors, cause the system to perform operations comprising:
generating, using a machine-learning (ML) model, an embedding for a current job position of a member of an online service, the ML model obtained by training a ML program with training data based on job transitions of members of the online service;
generating, by the ML model, embeddings for a plurality of career transitions, of a plurality of members of the online service, that occurred within a predetermined time period;
for each career transition from the plurality of career transitions, calculating a similarity value between the embedding of the career transition and the embedding for the current job position;
ranking the plurality of career transitions based on the similarity values;
generating a career insight for the member based on the ranked plurality of career transitions; and
causing presentation of the career insight on a user interface.

13. The system as recited in claim 12, wherein the instructions further cause the one or more computer processors to perform operations comprising:
predicting, by a prediction ML model, a next job position for the member based on a current job position of the member and profile information of the member, the prediction ML model being generated with prediction training data comprising the embeddings for the plurality of career transitions and profile information of the members of the online service.

14. The system as recited in claim 12, wherein the training data comprises features comprising one or more of time that a member has stayed in a job position before changing to another job position, highest education degree of the member, value indicating if the member changed company in the transition, value indicating if the member changed occupation in the transition, value indicating if the member changed industry in the transition, a similarity value between member's current skill set and skills set needed for a destination job position of the transition, and value indicating if the member moved up, stayed at same level, or moved with regard to seniority in the transition.

15. The system as recited in claim 12, wherein the embeddings for the plurality of career transitions are vectors with a smaller dimension than the embedding for the current job position.

16. The system as recited in claim 12, wherein the career insight is for suggesting one or more career paths for the member.

17. A tangible machine-readable storage medium including instructions that, when executed by a machine, cause the machine to perform operations comprising:
generating, using a machine-learning (ML) model, an embedding for a current job position of a member of an online service, the ML model obtained by training a ML program with training data based on job transitions of members of the online service;
generating, by the ML model, embeddings for a plurality of career transitions, of a plurality of members of the online service, that occurred within a predetermined time period;
for each career transition from the plurality of career transitions, calculating a similarity value between the embedding of the career transition and the embedding for the current job position;
ranking the plurality of career transitions based on the similarity values;
generating a career insight for the member based on the ranked plurality of career transitions; and
causing presentation of the career insight on a user interface.

18. The tangible machine-readable storage medium as recited in claim 17, wherein the machine further performs operations comprising:
predicting, by a prediction ML model, a next job position for the member based on a current job position of the member and profile information of the member, the prediction ML model being generated with prediction training data comprising the embeddings for the plurality of career transitions and profile information of the members of the online service.

19. The tangible machine-readable storage medium as recited in claim 17, wherein the training data comprises features comprising one or more of:
time that a member has stayed in a job position before changing to another job position, highest education degree of the member, value indicating if the member changed company in the transition, value indicating if the member changed occupation in the transition, value indicating if the member changed industry in the transition, a similarity value between member's current skill set and skills set needed for a destination job position of the transition, and value indicating if the member moved up, stayed at same level, or moved with regard to seniority in the transition.

20. The tangible machine-readable storage medium as recited in claim 17, wherein the embeddings for the plurality of career transitions are vectors with a smaller dimension than the embedding for the current job position.
